(19) United States
(12) Patent Application Publication
(10) Pub. No.: US 2025/0271573 A1
(43) Pub. Date: Aug. 28, 2025

(54) METHOD FOR REAL-TIME AND DISTRIBUTED FEATURE EXTRACTION USING IN-BAND POINT-TO-FEATURE INFORMATION

(71) Applicant: Lumentum Operations LLC, San Jose, CA (US)

(72) Inventor: Sylvain LEDUC, Gatineau (CA)

(21) Appl. No.: 18/627,117

(22) Filed: Apr. 4, 2024

Related U.S. Application Data
(60) Provisional application No. 63/558,956, filed on Feb. 28, 2024.

(51) Int. Cl. G01S 17/42; G01S 7/48; G01S 17/89

(52) U.S. Cl. CPC G01S 17/42; G01S 7/4802; G01S 17/89

(57) ABSTRACT

A beam scanning system includes a controller configured to receive a scan plan that includes a plurality of measurement points arranged in a 2D scanning pattern; a detector configured to generate instances of measurement data based on reflected light beams; and one or more second processors. The controller tags each instance of measurement data with an instance of respective scanning metadata corresponding to a respective measurement point to generate tagged measurement data. The one or more second processors monitor a progress of a feature scan corresponding to a feature located in the scanning area based on one or more instances of respective scanning metadata included in one or more instances of tagged measurement data in order to detect a completion of the feature scan, and extract the feature from a corresponding set of tagged measurement data in response to the progress of the feature scan being completed.

### CROSS-REFERENCE TO RELATED APPLICATION

This patent application claims priority to U.S. Provisional Patent Application No. 63/558,956, filed on Feb. 28, 2024, and entitled “METHOD FOR REAL-TIME AND DISTRIBUTED FEATURE EXTRACTION USING IN-BAND POINT-TO-FEATURE INFORMATION.” The disclosure of the prior application is considered part of and is incorporated by reference into this patent application.

### TECHNICAL FIELD

The present disclosure relates generally to beam scanning systems and methods for controlling beam scanning systems.

### BACKGROUND

A scanning system may use two-dimensional (2D) scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Transmitted light beams may be reflected back to the scanning system from one or more objects in the FOV as reflected light beams. A three-dimensional (3D) image of a scanned scene or a scanned object can then be generated based on distance measurements corresponding to the transmitted/reflected light beams. Additionally, or alternatively, the reflected light beams may be used by the scanning system to detect objects within the FOV for further processing.

### SUMMARY

In some implementations, a beam scanning system includes a controller comprising a first processor configured to receive a scan plan that includes a plurality of measurement points arranged in a 2D scanning pattern, wherein the first processor is configured to generate control signals for performing a 2D scan of a scanning area according to the 2D scanning pattern; a light transmitter controlled by the controller and configured to transmit a sequence of light beams based on the 2D scanning pattern; a beam scanner controlled by the controller and configured to direct each light beam at a respective measurement point based on the 2D scanning pattern; a detector comprising at least one sensor configured to generate instances of measurement data based on reflected light beams corresponding to the sequence of light beams, wherein each instance of measurement data corresponds to a respective measurement point, wherein the first processor is configured to tag each instance of measurement data with an instance of respective scanning metadata corresponding to the respective measurement point associated with the instance of measurement data, and transmit the instance of respective scanning metadata in-band with the instance of measurement data as an instance of tagged measurement data; and one or more second processors configured to receive each instance of tagged measurement data, monitor a progress of a first feature scan corresponding to a first feature located in the scanning area based on one or more instances of respective scanning metadata included in one or more first instances of tagged measurement data in order to detect a completion of the first feature scan, and extract the first feature from a first corresponding set of tagged measurement data in response to the progress of the first feature scan being completed.

In some implementations, a beam scanning system includes a controller comprising a first processor configured to receive a scan plan that includes a plurality of measurement points arranged in a 2D scanning pattern and an instance of respective scanning metadata for each measurement point within the 2D scanning pattern, wherein the first processor is configured to generate control signals for performing a 2D scan of a scanning area according to the 2D scanning pattern; a light transmitter controlled by the controller and configured to transmit a sequence of light beams based on the 2D scanning pattern; a beam scanner controlled by the controller and configured to direct each light beam at a respective measurement point based on the 2D scanning pattern; a detector comprising at least one sensor configured to generate instances of measurement data based on reflected light beams corresponding to the sequence of light beams, wherein each instance of measurement data corresponds to a respective measurement point, wherein the first processor is configured to tag each instance of measurement data with the instance of respective scanning metadata corresponding to the respective measurement point associated with the instance of measurement data, and transmit the instance of respective scanning metadata in-band with the instance of measurement data as an instance of tagged measurement data; and one or more second processors configured to receive each instance of tagged measurement data, monitor a progress of a first feature scan corresponding to a first feature located in the scanning area based on one or more instances of respective scanning metadata included in one or more first instances of tagged measurement data in order to detect a completion of the first feature scan, and extract the first feature from a first corresponding set of tagged measurement data in response to the progress of the first feature scan being completed.

In some implementations, a method includes generating, by a controller, a control signals for performing a 2D scan of a scanning area according to a 2D scanning pattern, the 2D scanning pattern being configured based on a scan plan that includes a plurality of measurement points arranged in the 2D scanning pattern; transmitting, by a light transmitter, a sequence of light beams based on the 2D scanning pattern; directing, by a beam scanner, each light beam at a respective measurement point based on the 2D scanning pattern; generating, by a detector, instances of measurement data based on reflected light beams corresponding to the sequence of light beams, wherein each instance of measurement data corresponds to a respective measurement point; tagging, by the controller, each instance of measurement data with an instance of respective scanning metadata corresponding to the respective measurement point associated with the instance of measurement data; transmitting, by the controller, the instance of respective scanning metadata in-band with the instance of measurement data as an instance of tagged measurement data; receiving, by at least one processor, each instance of tagged measurement data; monitoring, by the at least one processor, a progress of a first feature scan corresponding to a first feature located in the scanning area based on one or more instances of respective scanning metadata included in one or more first instances of tagged measurement data in order to detect a completion of the first feature scan; and extracting, by the at least one processor, the first feature from a first corresponding set of tagged measurement data in response to the progress of the first feature scan being completed.

### BRIEF DESCRIPTION OF THE DRAWINGS

FIG. 1 is a schematic block diagram of a 2D scanning system according to one or more implementations.

FIG. 2 is a schematic block diagram of a beam scanning control system according to one or more implementations.

FIG. 3 is a flow diagram of a beam scanning control method according to one or more implementations.

FIG. 4 is a beam scanning system according to one or more implementations.

### DETAILED DESCRIPTION

The following detailed description of example implementations refers to the accompanying drawings. The same reference numbers in different drawings may identify the same or similar elements.

A 2D scan may be used to scan a 3D scene or a 3D object. While light may be scanned in two dimensions, a third dimension (e.g., a depth dimension) may be obtained from distance measurements. The distance measurements may be performed based on a time-of-flight of transmitted and reflected light beams. 2D scanning coordinates along with distance information may be used to generate a point cloud of a scanned environment.

In traditional metrology workflows, a point cloud is fully collected before initiating feature extraction (e.g., object detection), resulting in a sequential operation of scanning, and then processing. This sequential approach is not well-suited for in-line metrology, where adherence to takt times—derived from the German term for production rhythm—is critical for efficient throughput.

Advanced real-time techniques that employ statistical methods exist to enable feature extraction concurrently with a scanning process. By determining when enough points within a specific volume have been collected, these real-time techniques initiate preliminary feature extraction without waiting for the scan to complete. The real-time techniques are computationally demanding and require high-levels of processing power. Additionally, results generated in this manner generally serve as preliminary insights and are usually subject to a post-scan refinement phase for validation and confirmation. Thus, these real-time techniques require additional processing, additional computation power, and additional time to post-process the pre-processed results.

Some implementations facilitate concurrent feature extraction during a scanning phase of a measurement operation, thereby minimizing an aggregate time spent on both scanning and processing to a timeframe that closely approximates a scanning duration of the scanning phase alone. Some implementations provide a technique capable of extracting an almost limitless number of features, contingent upon sufficient computational resources, within mere seconds following a completion of a scan.

A scan plan (e.g., a scanning pattern) may be translated into a program and then run by a specialized processor to collect measurement points. A scan plan organizes a collection process into distinct scan layers (e.g., scan passes) and scan lines. As a scan proceeds, each measurement is tagged with a corresponding scan layer and scan line, as metadata, by the specialized processor executing a scanning program. This metadata is transmitted in-band along with point cloud data, enabling a processor within the system to initiate feature extraction as soon as data corresponding to one or more layers, or one or more scan lines related to a specific feature, traverses the system. This approach allows real-time feature extraction by the sensor itself and any other computing node within the system. The complexity of point-to-feature correspondence is simplified to a minimum by avoiding costly spatial computations, statistical analysis, and a need for post-scan refinements.

One potential use-case for this approach is to enable the sensor to terminate a scan prematurely if the feature extraction for object presence fails, thereby avoiding the need for a full-duration takt time scan. Another application involves distributing work to a server cluster on a per-feature basis, thereby facilitating scalable processing capable of handling thousands of feature extractions within a single takt time cycle.

The scanning method may include mapping (point-to-feature combiner) a measurement structure of the scan plan (high-level descriptive language) to a feature extraction plan (features). This process can be facilitated with a visual representation of the scan plan and the feature extraction plan.

Subsequently, each individual feature may be allocated either to the sensor, a sensor feature extractor, or to a computational node, compute node feature extractor, which may be realized by a single computer or multiple interconnected computers.

A processor instruction set (machine language) may be configured to record a scan layer and a scan line for each measured point. The processor instruction set be used by the specialized processor and/or the sensor to tag each measurement with metadata.

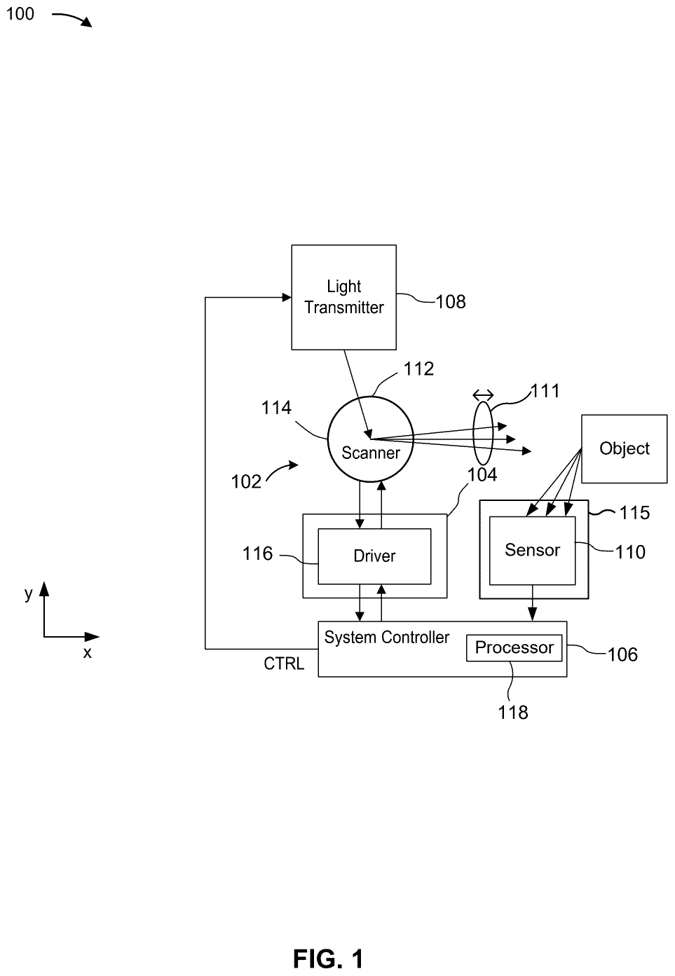

FIG. 1 is a schematic block diagram of a 2D scanning system 100 according to one or more implementations. In particular, the 2D scanning system 100 includes a scanner 102 configured to steer or otherwise deflect light beams according to a 2D scanning pattern for scanning 3D objects. The 2D scanning system 100 further includes a driver system 104, a system controller 106, and a light transmitter 108, and a sensor 110. In some implementations, the 2D scanning system 100 may be a 3D scanning system in which a movable lens 111 is provided. A position of the movable lens 111 may be adjusted along a beam path in order to change a focal length to an object (e.g., to a target). The focal length may be adjusted to ensure transmitted light beams remain focused on a surface of the object rather than becoming diffused, which would result in less reflected light, worse signal-to-noise ratio (SNR), and/or reduced precision. Thus, in some cases, 2D scanning of a scanning operation may refer to a scanning action of the scanner 102 (e.g., the scanning action of one or more scanning mirrors), and a third dimension of the scanning operation may refer to a movement of the movable lens 111 to change the focal length of the scan. The position of the movable lens 111 may be controlled by the system controller 106 based on a scan plan, which may be based on shapes and contours of the object.

In the example shown in FIG. 1, the scanner 102 may be a mechanical moving mirror and may be configured to rotate or oscillate via rotation about two scanning axes that are typically orthogonal to each other. For example, the two scanning axes may include a first scanning axis 112 that enables the scanner 102 to steer light in a first scanning direction (e.g., an x-direction) and a second scanning axis 114 (e.g., an inner scanning axis) that enables the scanner 102 to steer light in a second scanning direction (e.g., a y-direction). As a result, the scanner 102 can direct light beams in two dimensions according to the 2D scanning pattern.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the 2D scanning system 100 may be configured to transmit successive light beams (e.g., as successive light pulses) in different scanning directions to scan the field-of-view. The scanner 102 can direct a transmitted light beam at a desired 2D measurement coordinate (e.g., an x-y coordinate) in the field-of-view, controlled by the system controller 106.

In some implementations, the scanner 102 may be arranged to receive transmitted light beams from the light transmitter 108 and steer (scan) the transmitted light beams into the field-of-view to perform a scanning of the environment. The transmitted light beams may be backscattered by one or more objects back toward the 2D scanning system 100 as reflected light beams, where the reflected light beams are detected by the sensor 110 that is part of a detector 115. For example, the sensor 110 may be a photodetector or a photodetector array. The sensor 110 may convert each reflected light beam into an electric signal (e.g., a current signal or a voltage signal) that may be further processed by the 2D scanning system 100 to generate object data or an image. In such implementations, the desired 2D measurement coordinate may correspond to a particular transmission direction in the field-of-view that is targeted by the transmitted light beam for object detection or scanning, with different 2D measurement coordinates corresponding to different transmission directions. The system controller 106 may receive electrical signals from the sensor 110 and perform signal processing on the electrical signals for object feature detection. Thus, the detector 115 may include one or more sensors 110 configured to generate instances of measurement data based on reflected light beams.

Accordingly, multiple light beams transmitted at different transmission times can be steered by the scanner 102 at the different 2D measurement coordinates of the field-of-view in accordance with the 2D scanning pattern. The scanner 102 can be used to scan the field-of-view in both scanning directions by changing an angle of deflection of the scanner 102 on each of the first scanning axis 112 and the second scanning axis 114.

The driver system 104 may be configured to generate driving signals (e.g., actuation signals) to drive the scanner 102 about the first scanning axis 112 and the second scanning axis 114. In particular, the driver system 104 may be configured to apply the driving signals to an actuator structure of the scanner 102. In some implementations, the driver system 104 includes a driver 116 configured to drive the scanner 102 about the first scanning axis 112 and the second scanning axis 114. In implementations in which the scanner 102 is used as an oscillator, the driver 116 may be configured to drive an oscillation of the scanner 102 about the first scanning axis 112 at a first frequency, and drive an oscillation of the scanner 102 about the second scanning axis 114 at a second frequency.

The driver 116 may be configured to receive feedback information from the scanner 102, such as rotational position information. The system controller 106 may use the rotational position information to trigger light beams at the light transmitter 108. For example, the system controller 106 may use the rotational position information to set a transmission time of light transmitter 108 in order to target a particular 2D measurement coordinate of the 2D scanning pattern.

In some implementations, the system controller 106 is configured to set a driving frequency of the scanner 102 for each scanning axis and is capable of synchronizing the oscillations about the first scanning axis 112 and the second scanning axis 114. In particular, the system controller 106 may be configured to control an actuation of the scanner 102 about each scanning axis by controlling the driving signals. The system controller 106 may control the frequency, the phase, the duty cycle, and/or a voltage level of the driving signals to control the actuations about the first scanning axis 112 and the second scanning axis 114. The actuation of the scanner 102 about a particular scanning axis controls its range of motion and scanning rate about that particular scanning axis.

The light transmitter 108 may include one or more light sources, such as one or more laser diodes or one or more light emitting diodes, for generating one or more light beams. In some implementations, the light transmitter 108 may be configured to sequentially transmit a plurality of light beams (e.g., light pulses) as the scanner 102 changes its transmission direction in order to target different 2D measurement coordinates. The plurality of light beams may include visible light, infrared (IR) light, or other types of illumination signals, depending on an application of the 2D scanning system 100. A transmission sequence of the plurality of light beams and a timing thereof may be implemented by the light transmitter 108 according to a control signal CTRL received from the system controller 106.

The system controller 106 may be configured to control components of the 2D scanning system 100. In certain applications, the system controller 106 may also be configured to receive programming information with respect to the 2D scanning pattern and control a timing of the plurality of light beams generated by the light transmitter 108 based on the programming information. Thus, the system controller 106 may include both processing and control circuitry that is configured to generate control signals for controlling the light transmitter 108 and the driver 116. For example, the system controller 106 may include a processor 118 configured to execute machine instructions, and, based on executing the machine instructions, generate control signals for controlling the 2D scanning system 100 to perform a 2D scan of the scanning area according to the 2D scanning pattern. For example, the processor 118, in conjunction with control circuitry, may control the light transmitter 108 and the scanner 102 to target each 2D measurement coordinate with a respective light beam. The processor 118 may control the scanner 102 by controlling one or more parameters of the driver 116, such as the frequency, the phase, the duty cycle, and/or a voltage level of the driving signals used for driving each scanning axis 112 and 114.

The processor 118 may be a custom processor, a specialized processor, or a purpose-built processor configured to receive custom machine language instructions natively and execute the custom machine language instructions. The processor 118 may be designed specifically for executing the custom machine language instructions to perform a customized 2D scan, whereas a general-purpose processor may not be able to execute the custom machine language instructions to perform the customized 2D scan. The customized 2D scan may be customized for one or more characteristics of the 2D scanning system 100, as well as based on different levels of interest corresponding to different regions (e.g., regions of interest) within a scanning area. The processor 118 may be configured to, based on the custom machine language instructions, control and dynamically vary one or more scanning parameters in real-time while scanning the scanning area. In some implementations, the processor 118 may be implemented as an application-specific integrated circuit (ASIC), a field-programmable gate array (FPGA), or emulated in software executed on a custom processing device.

In some implementations, in which the plurality of light beams is used, the system controller 106 may be configured to generate the control signal CTRL used for triggering the light transmitter 108 to generate the plurality of light beams. Using the control signal CTRL, the system controller 106 can control the transmission times of the plurality of light beams of the light transmitter 108 to achieve a desired illumination pattern within the field-of-view. The desired illumination pattern is produced by a combination of the 2D scanning pattern produced by the scanner 102 and the transmission times triggered by the system controller 106.

In some implementations, the object data may be used during a manufacturing process of an object (e.g., a vehicle) to detect whether a part is assembled correctly and/or satisfies one or more specifications. Thus, the object data may be used to detect manufacturing faults that may occur during the manufacturing process.

Accordingly, the 2D scanning system 100 may include a detector that includes at least one sensor (e.g., sensor 110) and at least one signal processor (e.g., the processor 118 or other additional processors and/or processing components) implemented, for example, in the system controller 106. The sensor 110 may generate electrical signals based on reflected light beams corresponding to the light beams transmitted by the light transmitter 108. The sensor 110 may transmit the electrical signals to the at least one signal processor. The at least one signal processor may be configured to process the electrical signals to generate distance measurements based on the machine instructions for generating the object data. The at least one signal processor may be configured to analyze the object data based on the machine instructions to detect manufacturing faults.

As indicated above, FIG. 1 is provided as an example. Other examples may differ from what is described with regard to FIG. 1. In practice, the 2D scanning system 100 may include additional components, fewer components, different components, or differently arranged components than those shown in FIG. 1 without deviating from the disclosure provided above. In addition, in some implementations, the 2D scanning system 100 may include one or more additional mirrors to scan the field-of-view. For example, a first mirror (e.g., a first scanner) may be configured to rotate about the first scanning axis 112, and a second mirror (e.g., a second scanner) may be configured to rotate about the second scanning axis 114. The first mirror and the second mirror may be arranged in series along a transmission path of a light beam, and may be optically coupled to each other in order to steer the light beam in two-dimensions.

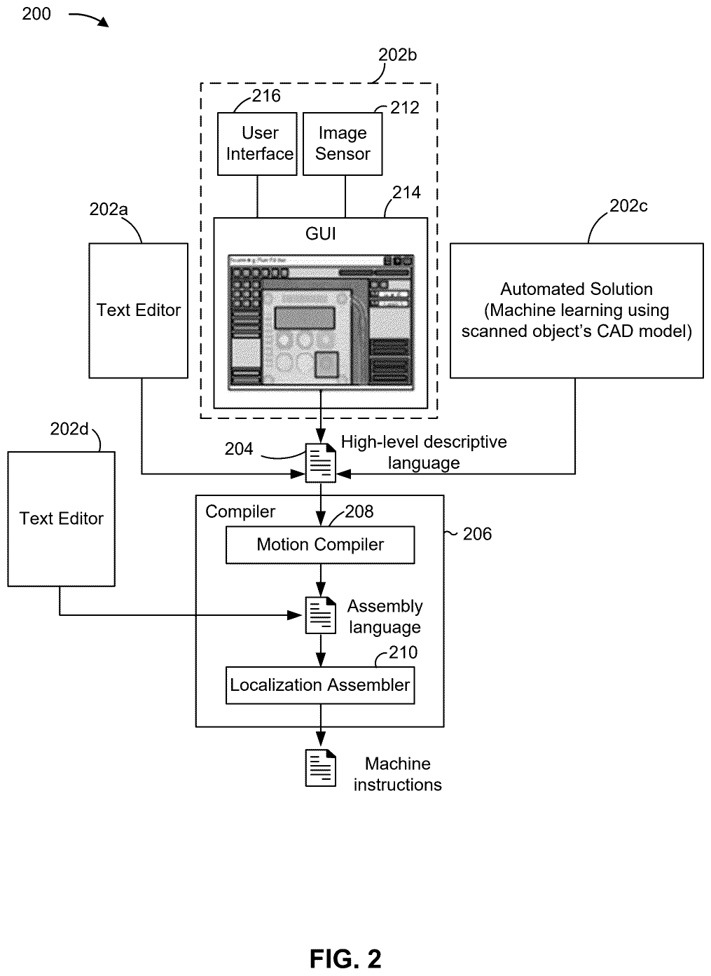

FIG. 2 is a schematic block diagram of a beam scanning control system 200 according to one or more implementations. The beam scanning control system 200 includes one or more input devices 202a, 202b, 202c, or 202d, an editor processor 204, and a compiler 206. The compiler 206 may include a motion compiler 208 and a localization assembler 210. The compiler 206 may include one or more processors for compiling and assembling programming language or code. Thus, the motion compiler 208 and the localization assembler 210 may be realized, at least in part, by one or more processors. In some implementations, the compiler 206 may be part of they system controller 106.

One or more of the input devices 202a, 202b, or 202c may include or may be operatively coupled to the editor processor 204 for generating a high-level descriptive language. The high-level descriptive language may provide an ability to generate a scanning program using vectorized shapes (rectangles, triangles, circles, etc.) and scanning parameters values for one or more scanning parameters, such as a measurement point density, a beam speed, a measurement acquisition rate, a focal length, or an integration time. The high-level descriptive language may define to a plurality of scanning regions of the scanning area and a plurality of scanning parameter subsets corresponding to the plurality of scanning regions, where each scanning parameter subset corresponds to a respective scanning region of the plurality of scanning regions, and where each scanning parameter subset is defined by scanning parameter values for a plurality of scanning parameters for the respective scanning region.

One or more of the input devices 202a, 202b, or 202c may be configured to define vectorized shapes for the plurality of scanning regions, and define the scanning parameter values for each scanning parameter subset. Each vectorized shape may define a respective scanning region of the plurality of scanning regions of the scanning area.

The input device 202a may include a text editor configured to receive the high-level descriptive language (e.g., from user input) and provide the high-level descriptive language to the motion compiler 208. The input device 202a may include the editor processor 204 for generating the high-level descriptive language, including a high-level scan plan, based on the user input. The high-level scan plan may be written with a high-level descriptive language to outline one or more scanning parameters, such as focal length, point density, scan speed, and/or scan mode, and one or more scanning strategies, such as a number of scan layers, an ordering of the scan layers, regions of interest, and/or a preferred scanning pattern.

The input device 202b may include an image sensor 212 configured to generate an image of a target object, a display 214 configured to display the image and a graphical user interface (GUI) overlaid on the image, and a user interface 216, such as a keyboard, a mouse, and/or a touch screen configured to receive user input that defines the vectorized shapes in the graphical user interface and the scanning parameter values of the plurality of scanning parameter subsets. For example, a user may use the user interface 216 to draw or otherwise define the vectorized shapes on the GUI. Each vectorized shape may correspond to a respective scanning region of the plurality of scanning regions of the scanning area. In addition, the input device 202b may include at least one processor (e.g., the editor processor 204) configured to generate the high-level descriptive language based on the user input.

The input device 202c may include at least one processor (e.g., the editor processor 204) configured to process, with a machine learning model, one or more geometric models of a target object to identify vectorized shapes corresponding to the target object and to define the scanning parameter values of the plurality of scanning parameter subsets. For example, the at least one processor may electronically receive one or more computer-aided drafting (CAD) models as the one or more geometric models, and may analyze the one or more CAD models with the machine learning model to identify the vectorized shapes and to determine the scanning parameter values based on the vectorized shapes. Each vectorized shape may correspond to a respective scanning region of the plurality of scanning regions of the scanning area. In addition, the at least one processor may generate, with the machine learning model, the high-level descriptive language based on the vectorized shapes and the scanning parameter values of the plurality of scanning parameter subsets.

The motion compiler 208 may receive the high-level descriptive language, calculate an adapted scan plan, including a 2D scanning pattern, based on the high-level scan plan (e.g., the high-level descriptive language), and generate assembly instructions based on the high-level scan plan. The motion compiler 208 may determine the 2D scanning pattern by adapting the high-level scan plan based on one or more characteristics of the 2D scanning system 100 to plan a best scanning trajectory (e.g., fastest, most efficient scanning trajectory) according to the desired scanning pattern described in the high-level scan plan. Thus, the motion compiler 208 may generate, based on the high-level scan plan, the adapted scan plan that includes a trajectory plan for each scan layer of a scan. The adapted scan plan may include a plurality of measurement points arranged in the 2D scanning pattern. The adapted scan plan may include scan layers, scan lines within each scan layer, and scan points within each scan line. The assembly language may be any low-level programming language with a high-level of correspondence between the high-level descriptive language and machine instructions (e.g., a processor instruction set). Each machine language instruction may have a one-to-one correlation to a unique mnemonic representation of the command provided in the assembly language.

The assembly instructions may be product family specific. In other words, the assembly instructions may be generated for a specific product that is intended to be a target of a 2D scan. Thus, different assembly instructions may be generated for different products or different product families. In some implementations, the input device 202d (e.g., a text editor) may provide additional assembly instructions or modifications to the assembly instructions. The adapted scan plan may be provided with the assembly instructions, or may be incorporated in the assembly instructions, to the localization assembler 210. The assembly instructions may describe the adapted scan plan (e.g., the output of the motion compiler 208).

The localization assembler 210 may receive the assembly instructions, and compile the assembly instructions into the machine instructions (e.g., custom machine language instructions) based on one or more characteristics of a 2D scanning system (e.g., the 2D scanning system 100). The localization assembler 210 may generate the machine instructions based on the one or more characteristics of the 2D scanning system 100 such that a scan time of the 2D scan is minimized based on one or more physical limits of the 2D scanning system 100. The one or more physical limits may correspond to one or more characteristics of the scanner 102, one or more characteristics of the light transmitter 108, and/or one or more characteristics of the sensor 110.

The machine instructions may be a set of low-level machine language instructions for the processor 118 to perform a scan and to perform related setup and signal processing as directed by the set of low-level machine language instructions. The machine instructions may include, but are not limited to, memory access, variable assignment, variable manipulation, flow control, task/event sequencing, complex commands utilizing variables/parameters/memory, mathematical operators, comparison operators, and specialized commands. For example, the processor 118 may execute the machine instructions, and, based on executing the machine instructions, generate control signals for controlling the 2D scanning system 100 to perform the 2D scan of the scanning area according to the adapted scan plan, including the 2D scanning pattern. The machine instructions may instruct the processor 118 and/or the sensor 110 to tag each measurement with scanning metadata (e.g., respective scanning metadata) that corresponds to the measurement within the adapted scan plan. The adapted scan plan may be provided to the processor 118 for extracting scanning metadata from the adapted scan plan, or the adapted scan plan with may be incorporated into the machine instructions along with the scanning metadata. In some implementations, the processor 118 may derive the scanning metadata from the adapted scan plan.

The 2D scanning pattern includes a trajectory of the 2D scanning pattern and 2D measurement coordinates within each scanning region of the plurality of scanning regions. Accordingly, each 2D measurement coordinate is located on the trajectory. The processor 118, based on executing the machine instructions, may control the light transmitter 108 and the scanner 102 to target each 2D measurement coordinate with a respective light beam.

The plurality of scanning parameters may include the measurement point density that defines a density of the 2D measurement coordinates. Thus, each vectorized shape or scanning region within the scanning area may be associated with a corresponding measurement point density. Thus, a scanning region with low-geometry features (e.g., features with no or low-degree of variance in geometry) may be associated with a low measurement point density provided by one or more of the input devices 202a, 202b, or 202c. In contrast, a scanning region with high-geometry features (e.g., features with a high-degree of variance in geometry) may be associated with a high measurement point density provided by one or more of the input devices 202a, 202b, or 202c. In some implementations, each scanning region may be associated with two or more scanning parameter values for a plurality of scanning parameters.

In some implementations, the high-level descriptive language may define each scanning region of the plurality of scanning regions as a vectorized shape having a defined contour. In addition, the 2D scanning pattern may include a plurality of scanning patterns, with each scanning pattern of the plurality of scanning patterns being bound by the defined contour of a respective vectorized shape. In other words, different scanning patterns within the scanning area may be created by the motion compiler 208 for different scanning regions. Thus, the scanning pattern may change as the 2D scan progresses from one scanning region to another scanning region within a same scanning cycle. As a result, the trajectory of the 2D scanning pattern may not be uniform throughout the scanning area, but may vary according to the different scanning patterns. The motion compiler 208 may link each of the different scanning patterns with a respective scanning parameter subset. Thus, the motion compiler 208 may calculate the different scanning patterns based on the high-level descriptive language. The assembly language may define the different scanning patterns, the scanning region of each scanning pattern, and the respective scanning parameter subset of each scanning pattern based on the high-level descriptive language.

The machine instructions set may be stored on a storage medium (e.g., a memory device) of the system controller 106 or on a storage medium the system controller 106 can access (e.g., by read operations). Thus, the compiler 206 may provide the machine instructions to the system controller 106, which stores the machine instructions in memory for execution by the processor 118, or to another memory device.

As indicated above, FIG. 2 is provided as an example. Other examples may differ from what is described with regard to FIG. 2.

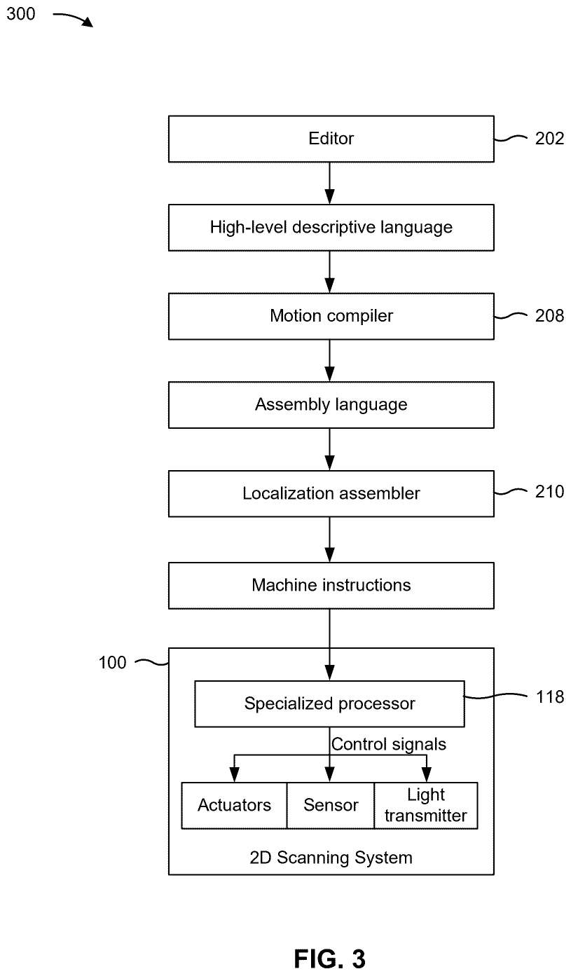

FIG. 3 is a flow diagram 300 of a beam scanning control method according to one or more implementations. An input device 202, such as input device 202a, input device 202b, or input device 202c, is configured to provide the high-level descriptive language to the motion compiler 208. The motion compiler 208 is configured to calculate a 2D scanning pattern based on the high-level descriptive language, and generate assembly instructions based on the 2D scanning pattern. The motion compiler 208 is configured to provide the assembly instructions to the localization assembler 210. The localization assembler 210 is configured to compile the assembly instructions into machine instructions based on one or more characteristics of a 2D scanning system 100, and provide the machine instructions to the processor 118 of the system controller 106. The processor 118 is configured to execute the machine instructions, and, based on executing the machine instructions, the system controller 106 is configured to generate control signals for controlling the 2D scanning system 100 to perform a 2D scan of the scanning area according to the 2D scanning pattern. The control signals may be used to control one or more actuators (e.g., one or more actuators of the scanner 102), one or more sensors (e.g., sensor 110), and/or one or more light transmitters (e.g., light transmitter 108).

As indicated above, FIG. 3 is provided as an example. Other examples may differ from what is described with regard to FIG. 3.

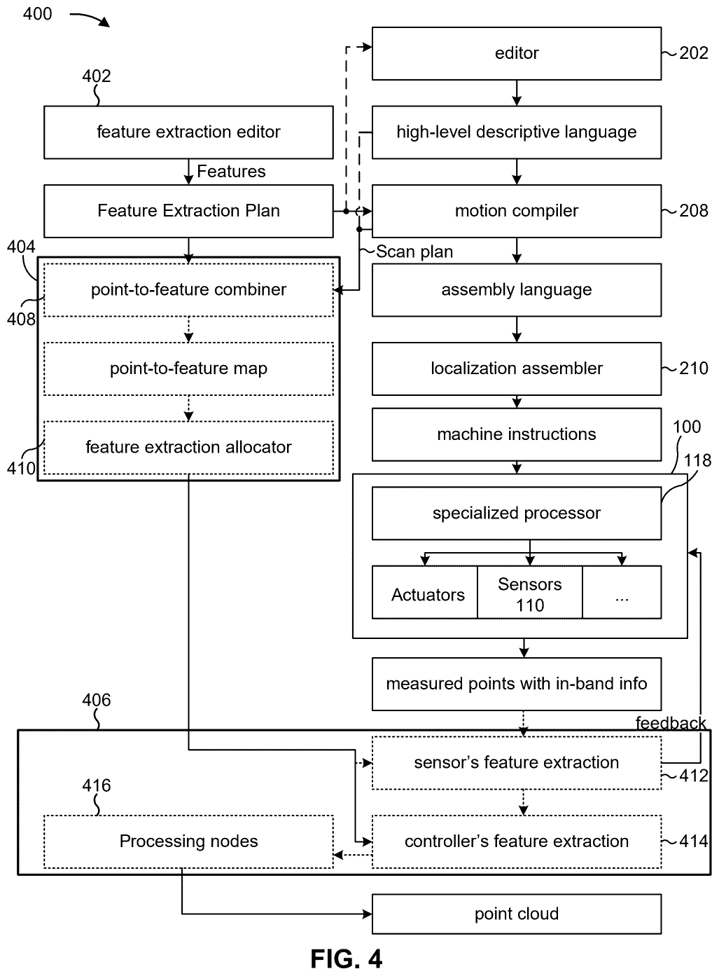

FIG. 4 is a beam scanning system 400 according to one or more implementations. The beam scanning system 400 may perform a measurement operation in order to generate a point cloud. The beam scanning system 400 may include the input device 202, the motion compiler 208, the localization assembler 210, and the processor 118 (e.g., a specialized processor), as described in connection with FIGS. 1-3. The processor 118 may be referred to as a “first processor.”

In addition, the beam scanning system 400 may include a feature extraction editor 402, a first processing unit 404, and a second processing unit 406. The first processing unit 404 may include one or more additional processors. For example, the first processing unit 404 may include a single additional processor or a distributed set of additional processors. The second processing unit 406 may include one or more additional processors. For example, the second processing unit 406 may include a single additional processor or a distributed set of additional processors. In some implementations, the first processing unit 404 and the second processing unit 406 may share one or more of the additional processors. Thus, the first processing unit 404 and the second processing unit 406 may include one or more additional processors, which may be referred to as “second processors.” In some implementations, the first processing unit 404 and/or the second processing unit 406 may be part of the system controller 106.

The first processing unit 404 may include a point-to-feature combiner 408 and a feature extraction allocator 410. The point-to-feature combiner 408 and the feature extraction allocator 410 may be implemented as one or more second processors. The second processing unit 406 may include a sensor feature extractor 412, a controller feature extractor 414, and one or more processing nodes 416. The sensor feature extractor 412, the controller feature extractor 414, and the one or more processing nodes 416 may be implemented as one or more second processors.

The processor 118 may receive a scanning program of the adapted scan plan that includes a plurality of measurement points arranged in a 2D scanning pattern. Additionally, the adapted scan plan may include an instance of respective scanning metadata for each measurement point within the 2D scanning pattern. For example, each instance of respective scanning metadata may include coordinate information for the respective measurement point within the adapted scan plan. For example, the coordinate information may represent a coordinate within the adapted scan plan. In some implementations, each instance of respective scanning metadata includes a scan layer identifier corresponding to a scan layer of the adapted scan plan, a scan line identifier corresponding to a scan line within the scan layer of the adapted scan plan, and an index identifier that corresponds to a point within the scan line of the adapted scan plan.

The processor 118 may generate control signals for performing a 2D scan of a scanning area according to the 2D scanning pattern (e.g., according to the adapted scan plan). The light transmitter 108 shown in FIG. 1 may be controlled by the processor 118 and is configured to transmit a sequence of light beams based on the 2D scanning pattern. The scanner 102 shown in FIG. 1 may be controlled by the processor 118 and is configured to direct each light beam at a respective measurement point based on the 2D scanning pattern. The one or more sensors 110 may generate instances of measurement data based on reflected light beams corresponding to the sequence of light beams. Each instance of measurement data may correspond to a respective measurement point within the 2D scanning pattern. The instances of measurement data may be point cloud data to be used for generating a point cloud.

The processor 118 may tag each instance of measurement data with an instance of respective scanning metadata corresponding to the respective measurement point associated with the instance of measurement data, and transmit the instance of respective scanning metadata in-band with the instance of measurement data to the second processing unit 406 as an instance of tagged measurement data. In other words, the instance of respective scanning metadata is transmitted in a same data stream as the instance of measurement data.

The feature extraction editor 402 may include an input device and a processor configured to identify and/or extract one or more features of one or more objects to be scanned in the scanning area (e.g., from user input). Based on the identified features, the feature extraction editor 402 may generate a feature extraction plan that corresponds to one or more features located or identified in the scanning area. In some implementations, the feature extraction editor 402 may provide the feature extraction plan to a high-level description language generator, such as the input device 202, for generating the high-level description language, including the high-level scan plan, from the feature extraction plan. In some implementations, the feature extraction editor 402 may provide the feature extraction plan to the motion compiler 208, and the motion compiler 208 may generate the adapted scan plan based on the feature extraction plan, in which case the input device 202 may not be needed. The high-level scan plan from the high-level description language generator or the adapted scan plan from the motion compiler 208 may be provided to the first processing unit 404 (e.g., to the point-to-feature combiner 408).

The point-to-feature combiner 408 may map each feature within the feature extraction plan to a corresponding section of the adapted scan plan (or the high-level scan plan) to generate a point-to-feature map for each feature. In other words, each measurement point in the adapted scan plan (or the high-level scan plan) is mapped to or otherwise assigned to one or more features within the feature extraction plan. The point-to-feature combiner 408 may map each feature within the feature extraction plan to a corresponding section of the adapted scan plan to generate a point-to-feature map for each feature provided in the feature extraction plan.

For the sake of simplicity, the measurement operation may be described with respect to scanning a first feature and a second feature in the scanning area, with each feature having a point-to-feature map corresponding to a respective feature scan. Thus, the first feature may be scanned with a first feature scan according to the point-to-feature map for the first feature. The second feature may be scanned with a second feature scan according to the point-to-feature map for the second feature. The measurement operation may be performed for any number of features, including one or more features (e.g., one feature or a plurality of features).

The feature extraction allocator 410 may allocate each feature (e.g., each point-to-feature map) to the sensor feature extractor 412 and/or to the controller feature extractor 414. For example, the feature extraction allocator 410 may allocate the point-to-feature map for a feature to the sensor feature extractor 412 and/or to the controller feature extractor 414.

The sensor feature extractor 412 may compare the point-to-feature map associated with the first feature with the one or more instances of respective scanning metadata received in the one or more first instances of tagged measurement data, and determine whether the respective scanning metadata matched with the point-to-feature map associated with the first feature. For example, the sensor feature extractor 412 may determine with the scan layer identifier, the scan line identifier, and/or the index identifier of measurement point of the first feature matches with a point in the point-to-feature map. The sensor feature extractor 412 may determine that the first feature scan is faulty when there is a mismatch between the point-to-feature map associated with the first feature and the one or more instances of respective scanning metadata received in the one or more first instances of tagged measurement data. In some implementations, the sensor feature extractor 412 may abort the 2D scan based on the mismatch. In some implementations, the sensor feature extractor 412 may transmit a feedback signal to the processor 118 based on the mismatch. The processor 118 may, based on the feedback signal, adapt the 2D scan to account for the mismatch such that the point-to-feature map associated with the first feature is satisfied. For example, based on the feedback signal, the processor 118 may add one or more additional measurement point to the first feature scan such that the first feature scan satisfies the point-to-feature map. Additionally, or alternatively, based on the feedback signal, the processor 118 may add one or more additional scan passes (e.g., scan layers) to the first feature scan such that the first feature scan satisfies the point-to-feature map. If the scanning metadata of the first feature scan matches the point-to-feature map of the first feature, the controller feature extractor 414 may proceed with extracting the first feature based on a progress of the first feature scan.

The controller feature extractor 414 may receive each instance of tagged measurement data, monitor a progress of the first feature scan corresponding to the first feature located in the scanning area based on one or more instances of respective scanning metadata included in one or more first instances of tagged measurement data in order to detect a completion of the first feature scan, and extract the first feature from a first corresponding set of tagged measurement data in response to the progress of the first feature scan being completed. The controller feature extractor 414 may compare the point-to-feature map associated with the first feature with the one or more instances of respective scanning metadata received in the one or more first instances of tagged measurement data, and determine that the first feature scan is complete based on the point-to-feature map associated with the first feature being satisfied. For example, the first feature scan may be complete when the point-to-feature map associated with the first feature has been satisfied. In other words, the controller feature extractor 414 may determine that the first feature scan is complete when the scanning metadata corresponding to measurement points of the first feature satisfies all measurement points associated with the first feature in the point-to-feature map of the first feature. The controller feature extractor 414 may monitor the progress of the first feature scan during transmission of the sequence of light beams (e.g., during a beam scanning operation). In other words, the feature extraction may be performed in parallel with the beam scanning.

Once the controller feature extractor 414 determines that the first feature scan has been completed, the controller feature extractor 414 may provide the extracted first feature (e.g., the measurement data of the first feature) to the processing nodes 416. The processing nodes 416 may generate a point cloud of the first feature that is extracted from the first corresponding set of tagged measurement data based on the measurement data of the first feature received from the controller feature extractor 414.

The second processing unit 406 may monitor features scans in a similar manner for each feature, and extract each feature from a corresponding set of tagged measurement data based on a completion of the feature scan of that feature. For example, the controller feature extractor 414 may monitor a progress of the second feature scan corresponding to the second feature located in the scanning area based on one or more second instances of tagged measurement data in order to detect a completion of the second feature scan, and extract the second feature from a second corresponding set of tagged measurement data in response to the progress of the second feature scan being completed. The processing nodes 416 may generate a point cloud of the second feature that is extracted from the second corresponding set of tagged measurement data based on the measurement data of the second feature received from the controller feature extractor 414.

The controller feature extractor 414 may monitor the progress of the first feature scan in parallel with monitoring the progress of the second feature scan. Thus, as feature scans are completed, the processing nodes 416 may generate portions of a point cloud of the scanning area in batches, on a feature-by-feature basis, during transmission of the sequence of light beams. As a result, the processing nodes 416 do not need to wait until the entire beam scanning operation is complete to start generating portions of the point cloud, which may otherwise slow down point cloud generation. Instead, the tagged measurement data enables the processing nodes 416 to start generating portions of the point cloud as feature scans are determined to be complete by the controller feature extractor 414, which may be prior to completing of the entire beam scanning operation. As a result, a significant portion of the point cloud of the scanning area may be generated prior to completing of the entire beam scanning operation, thus accelerating point cloud generation.

In summary, the measured points (e.g., measurement data) may flow from the processor 118 to the second processing unit 406, which analyzes the point cloud data. The measured points may be transferred in small increments or batches from the processor 118 to the second processing unit 406 as the 2D scan progresses. The measurement points carry in-band metadata that corresponds to a scan plan layer and scan line. The measured points flow through the sensor feature extractor 412, which analyzes the in-band metadata to determine if the measured points match a pre-configured feature extraction. If the measured points matches the pre-configured feature extraction, feature extraction is performed upon completion of the feature scan for that feature. The controller feature extractor 414 may perform feature extraction locally or dispatch the feature extraction to one or more processing nodes 416. The point cloud may take shape incrementally as batches of measured points are received by the processing nodes 416. Thus, the outcomes of feature extractions are gathered in a stepwise manner as each feature analysis reaches completion.

The following provides an overview of some Aspects of the present disclosure:

Aspect 1: A beam scanning system, comprising: a controller comprising a first processor configured to receive a scan plan that includes a plurality of measurement points arranged in a 2D scanning pattern, wherein the first processor is configured to generate control signals for performing a 2D scan of a scanning area according to the 2D scanning pattern; a light transmitter controlled by the controller and configured to transmit a sequence of light beams based on the 2D scanning pattern; a beam scanner controlled by the controller and configured to direct each light beam at a respective measurement point based on the 2D scanning pattern; a detector comprising at least one sensor configured to generate instances of measurement data based on reflected light beams corresponding to the sequence of light beams, wherein each instance of measurement data corresponds to a respective measurement point, wherein the first processor is configured to tag each instance of measurement data with an instance of respective scanning metadata corresponding to the respective measurement point associated with the instance of measurement data, and transmit the instance of respective scanning metadata in-band with the instance of measurement data as an instance of tagged measurement data; and one or more second processors configured to receive each instance of tagged measurement data, monitor a progress of a first feature scan corresponding to a first feature located in the scanning area based on one or more instances of respective scanning metadata included in one or more first instances of tagged measurement data in order to detect a completion of the first feature scan, and extract the first feature from a first corresponding set of tagged measurement data in response to the progress of the first feature scan being completed.

Aspect 2: The beam scanning system of Aspect 1, wherein the one or more second processors are configured to monitor a progress of a second feature scan corresponding to a second feature located in the scanning area based on one or more second instances of tagged measurement data in order to detect a completion of the second feature scan, and extract the second feature from a second corresponding set of tagged measurement data in response to the progress of the second feature scan being completed.

Aspect 3: The beam scanning system of Aspect 2, wherein the one or more second processors are configured to monitor the progress of the first feature scan in parallel with monitoring the progress of the second feature scan.

Aspect 4: The beam scanning system of Aspect 2, wherein the one or more second processors are configured to generate portions of a point cloud of the scanning area in batches, on a feature-by-feature basis, during transmission of the sequence of light beams.

Aspect 5: The beam scanning system of any of Aspects 1-4, wherein the one or more second processors are configured to monitor the progress of the first feature scan during transmission of the sequence of light beams.

Aspect 6: The beam scanning system of any of Aspects 1-5, wherein the one or more second processors are configured to generate a point cloud of the first feature that is extracted from the first corresponding set of tagged measurement data.

Aspect 7: The beam scanning system of any of Aspects 1-6, wherein the instances of measurement data are point cloud data.

Aspect 8: The beam scanning system of any of Aspects 1-7, wherein each instance of respective scanning metadata includes coordinate information for the respective measurement point within the scan plan.

Aspect 9: The beam scanning system of any of Aspects 1-8, wherein each instance of respective scanning metadata includes a scan layer identifier corresponding to a scan layer of the scan plan, a scan line identifier corresponding to a scan line within the scan layer of the scan plan, and an index identifier that corresponds to a point within the scan line of the scan plan.

Aspect 10: The beam scanning system of any of Aspects 1-9, wherein the one or more second processors are configured to receive the scan plan and a feature extraction plan that corresponds to one or more features located in the scanning area, and map each feature within the feature extraction plan to a corresponding section of the scan plan to generate a point-to-feature map for each feature.

Aspect 11: The beam scanning system of Aspect 10, wherein the one or more second processors are configured to compare the point-to-feature map associated with the first feature with the one or more instances of respective scanning metadata received in the one or more first instances of tagged measurement data, and determine that the first feature scan is complete based on the point-to-feature map associated with the first feature being satisfied.

Aspect 12: The beam scanning system of Aspect 10, wherein the one or more second processors are configured to compare the point-to-feature map associated with the first feature with the one or more instances of respective scanning metadata received in the one or more first instances of tagged measurement data, and determine that the first feature scan is faulty when there is a mismatch between the point-to-feature map associated with the first feature and the one or more instances of respective scanning metadata received in the one or more first instances of tagged measurement data.

Aspect 13: The beam scanning system of Aspect 12, wherein the one or more second processors are configured to abort the 2D scan based on the mismatch.

Aspect 14: The beam scanning system of Aspect 12, wherein the one or more second processors are configured to transmit a feedback signal to the first processor based on the mismatch.

Aspect 15: The beam scanning system of Aspect 14, wherein the first processor is configured to, based on the feedback signal, adapt the 2D scan to account for the mismatch such that the point-to-feature map associated with the first feature is satisfied.

Aspect 16: The beam scanning system of any of Aspects 1-15, wherein the one or more second processors are configured to: generate a feature extraction plan based on one or more features identified in the scanning area; generate the scan plan based on the feature extraction plan; and map each feature within the feature extraction plan to a corresponding section of the scan plan to generate a point-to-feature map for each feature.

Aspect 17: The beam scanning system of Aspect 16, wherein the one or more second processors are configured to compare the point-to-feature map associated with the first feature with the one or more instances of respective scanning metadata received in the one or more first instances of tagged measurement data, and determine that the first feature scan is complete when the point-to-feature map associated with the first feature has been satisfied.

Aspect 18: A beam scanning system, comprising: a controller comprising a first processor configured to receive a scan plan that includes a plurality of measurement points arranged in a 2D scanning pattern and an instance of respective scanning metadata for each measurement point within the 2D scanning pattern, wherein the first processor is configured to generate control signals for performing a 2D scan of a scanning area according to the 2D scanning pattern; a light transmitter controlled by the controller and configured to transmit a sequence of light beams based on the 2D scanning pattern; a beam scanner controlled by the controller and configured to direct each light beam at a respective measurement point based on the 2D scanning pattern; a detector comprising at least one sensor configured to generate instances of measurement data based on reflected light beams corresponding to the sequence of light beams, wherein each instance of measurement data corresponds to a respective measurement point, wherein the first processor is configured to tag each instance of measurement data with the instance of respective scanning metadata corresponding to the respective measurement point associated with the instance of measurement data, and transmit the instance of respective scanning metadata in-band with the instance of measurement data as an instance of tagged measurement data; and one or more second processors configured to receive each instance of tagged measurement data, monitor a progress of a first feature scan corresponding to a first feature located in the scanning area based on one or more instances of respective scanning metadata included in one or more first instances of tagged measurement data in order to detect a completion of the first feature scan, and extract the first feature from a first corresponding set of tagged measurement data in response to the progress of the first feature scan being completed.

Aspect 19: The beam scanning system of Aspect 18, wherein each instance of respective scanning metadata includes coordinate information for the respective measurement point within the scan plan.

Aspect 20: A method, comprising: generating, by a controller, a control signals for performing a 2D scan of a scanning area according to a 2D scanning pattern, the 2D scanning pattern being configured based on a scan plan that includes a plurality of measurement points arranged in the 2D scanning pattern; transmitting, by a light transmitter, a sequence of light beams based on the 2D scanning pattern; directing, by a beam scanner, each light beam at a respective measurement point based on the 2D scanning pattern; generating, by a detector, instances of measurement data based on reflected light beams corresponding to the sequence of light beams, wherein each instance of measurement data corresponds to a respective measurement point; tagging, by the controller, each instance of measurement data with an instance of respective scanning metadata corresponding to the respective measurement point associated with the instance of measurement data; transmitting, by the controller, the instance of respective scanning metadata in-band with the instance of measurement data as an instance of tagged measurement data; receiving, by at least one processor, each instance of tagged measurement data; monitoring, by the at least one processor, a progress of a first feature scan corresponding to a first feature located in the scanning area based on one or more instances of respective scanning metadata included in one or more first instances of tagged measurement data in order to detect a completion of the first feature scan; and extracting, by the at least one processor, the first feature from a first corresponding set of tagged measurement data in response to the progress of the first feature scan being completed.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A beam scanning system, comprising:
a controller comprising a first processor configured to receive a scan plan that includes a plurality of measurement points arranged in a two-dimensional (2D) scanning pattern, wherein the first processor is configured to generate control signals for performing a 2D scan of a scanning area according to the 2D scanning pattern;
a light transmitter controlled by the controller and configured to transmit a sequence of light beams based on the 2D scanning pattern;
a beam scanner controlled by the controller and configured to direct each light beam at a respective measurement point based on the 2D scanning pattern;
a detector comprising at least one sensor configured to generate instances of measurement data based on reflected light beams corresponding to the sequence of light beams, wherein each instance of measurement data corresponds to a respective measurement point,
wherein the first processor is configured to tag each instance of measurement data with an instance of respective scanning metadata corresponding to the respective measurement point associated with the instance of measurement data, and transmit the instance of respective scanning metadata in-band with the instance of measurement data as an instance of tagged measurement data; and
one or more second processors configured to receive each instance of tagged measurement data, monitor a progress of a first feature scan corresponding to a first feature located in the scanning area based on one or more instances of respective scanning metadata included in one or more first instances of tagged measurement data in order to detect a completion of the first feature scan, and extract the first feature from a first corresponding set of tagged measurement data in response to the progress of the first feature scan being completed.

2. The beam scanning system of claim 1, wherein the one or more second processors are configured to monitor a progress of a second feature scan corresponding to a second feature located in the scanning area based on one or more second instances of tagged measurement data in order to detect a completion of the second feature scan, and extract the second feature from a second corresponding set of tagged measurement data in response to the progress of the second feature scan being completed.

3. The beam scanning system of claim 2, wherein the one or more second processors are configured to monitor the progress of the first feature scan in parallel with monitoring the progress of the second feature scan.

4. The beam scanning system of claim 2, wherein the one or more second processors are configured to generate portions of a point cloud of the scanning area in batches, on a feature-by-feature basis, during transmission of the sequence of light beams.

5. The beam scanning system of claim 1, wherein the one or more second processors are configured to monitor the progress of the first feature scan during transmission of the sequence of light beams.

6. The beam scanning system of claim 1, wherein the one or more second processors are configured to generate a point cloud of the first feature that is extracted from the first corresponding set of tagged measurement data.

7. The beam scanning system of claim 1, wherein the instances of measurement data are point cloud data.

8. The beam scanning system of claim 1, wherein each instance of respective scanning metadata includes coordinate information for the respective measurement point within the scan plan.

9. The beam scanning system of claim 1, wherein each instance of respective scanning metadata includes a scan layer identifier corresponding to a scan layer of the scan plan, a scan line identifier corresponding to a scan line within the scan layer of the scan plan, and an index identifier that corresponds to a point within the scan line of the scan plan.

10. The beam scanning system of claim 1, wherein the one or more second processors are configured to receive the scan plan and a feature extraction plan that corresponds to one or more features located in the scanning area, and map each feature within the feature extraction plan to a corresponding section of the scan plan to generate a point-to-feature map for each feature.

11. The beam scanning system of claim 10, wherein the one or more second processors are configured to compare the point-to-feature map associated with the first feature with the one or more instances of respective scanning metadata received in the one or more first instances of tagged measurement data, and determine that the first feature scan is complete based on the point-to-feature map associated with the first feature being satisfied.

12. The beam scanning system of claim 10, wherein the one or more second processors are configured to compare the point-to-feature map associated with the first feature with the one or more instances of respective scanning metadata received in the one or more first instances of tagged measurement data, and determine that the first feature scan is faulty when there is a mismatch between the point-to-feature map associated with the first feature and the one or more instances of respective scanning metadata received in the one or more first instances of tagged measurement data.

13. The beam scanning system of claim 12, wherein the one or more second processors are configured to abort the 2D scan based on the mismatch.

14. The beam scanning system of claim 12, wherein the one or more second processors are configured to transmit a feedback signal to the first processor based on the mismatch.

15. The beam scanning system of claim 14, wherein the first processor is configured to, based on the feedback signal, adapt the 2D scan to account for the mismatch such that the point-to-feature map associated with the first feature is satisfied.

16. The beam scanning system of claim 1, wherein the one or more second processors are configured to:
generate a feature extraction plan based on one or more features identified in the scanning area;
generate the scan plan based on the feature extraction plan; and
map each feature within the feature extraction plan to a corresponding section of the scan plan to generate a point-to-feature map for each feature.

17. The beam scanning system of claim 16, wherein the one or more second processors are configured to compare the point-to-feature map associated with the first feature with the one or more instances of respective scanning metadata received in the one or more first instances of tagged measurement data, and determine that the first feature scan is complete when the point-to-feature map associated with the first feature has been satisfied.

18. A beam scanning system, comprising:
a controller comprising a first processor configured to receive a scan plan that includes a plurality of measurement points arranged in a two-dimensional (2D) scanning pattern and an instance of respective scanning metadata for each measurement point within the 2D scanning pattern,
wherein the first processor is configured to generate control signals for performing a 2D scan of a scanning area according to the 2D scanning pattern;
a light transmitter controlled by the controller and configured to transmit a sequence of light beams based on the 2D scanning pattern;
a beam scanner controlled by the controller and configured to direct each light beam at a respective measurement point based on the 2D scanning pattern;
a detector comprising at least one sensor configured to generate instances of measurement data based on reflected light beams corresponding to the sequence of light beams, wherein each instance of measurement data corresponds to a respective measurement point,
wherein the first processor is configured to tag each instance of measurement data with the instance of respective scanning metadata corresponding to the respective measurement point associated with the instance of measurement data, and transmit the instance of respective scanning metadata in-band with the instance of measurement data as an instance of tagged measurement data; and
one or more second processors configured to receive each instance of tagged measurement data, monitor a progress of a first feature scan corresponding to a first feature located in the scanning area based on one or more instances of respective scanning metadata included in one or more first instances of tagged measurement data in order to detect a completion of the first feature scan, and extract the first feature from a first corresponding set of tagged measurement data in response to the progress of the first feature scan being completed.

19. The beam scanning system of claim 18, wherein each instance of respective scanning metadata includes coordinate information for the respective measurement point within the scan plan.

20. A method, comprising:
generating, by a controller, a control signals for performing a two-dimensional (2D) scan of a scanning area according to a 2D scanning pattern, the 2D scanning pattern being configured based on a scan plan that includes a plurality of measurement points arranged in the 2D scanning pattern;
transmitting, by a light transmitter, a sequence of light beams based on the 2D scanning pattern;
directing, by a beam scanner, each light beam at a respective measurement point based on the 2D scanning pattern;
generating, by a detector, instances of measurement data based on reflected light beams corresponding to the sequence of light beams, wherein each instance of measurement data corresponds to a respective measurement point;
tagging, by the controller, each instance of measurement data with an instance of respective scanning metadata corresponding to the respective measurement point associated with the instance of measurement data;
transmitting, by the controller, the instance of respective scanning metadata in-band with the instance of measurement data as an instance of tagged measurement data;
receiving, by at least one processor, each instance of tagged measurement data;
monitoring, by the at least one processor, a progress of a first feature scan corresponding to a first feature located in the scanning area based on one or more instances of respective scanning metadata included in one or more first instances of tagged measurement data in order to detect a completion of the first feature scan; and
extracting, by the at least one processor, the first feature from a first corresponding set of tagged measurement data in response to the progress of the first feature scan being completed.
